(19) United States
(12) Patent Application Publication
(10) Pub. No.: US 2007/0008714 A1
(43) Pub. Date: Jan. 11, 2007

(54) Handbag with illuminated panel

(76) Inventor: Rosanna Kilfedder, Edinburgh (GB)

Correspondence Address: INVITROGEN CORPORATION;C/O INTELLEVATE, P.O. BOX 52050, MINNEAPOLIS, MN, 55402, US

(21) Appl. No.: 11/410,176

(22) Filed: Apr. 24, 2006

(30) Foreign Application Priority Data
Jul. 6, 2005 (GB) GB0513906.8

(51) Int. Cl. F21V 21/08

(52) U.S. Cl. 362/103

(57) ABSTRACT

A handbag includes a fastener which has a slide member and a plurality of interlocking teeth which engage and interlock under the action of the slide member. A magnet is mounted on the slide member and a reed switch is mounted on a substrate which supports the plurality of interlocking teeth. The reed switch operates an electrical circuit to power an electroluminescent panel which is mounted in the handbag.

This application claims priority from Provisional Patent Application entitled “A Fastener Incorporating An Electrical Switch” which was filed in the United Kingdom as Application No. GB 0513906.8 on Jul. 6, 2005.

### FIELD OF THE INVENTION

The present invention relates generally to the field of handbags and more particularly, to a handbag incorporating an illuminated panel.

### BACKGROUND OF THE INVENTION

The field of handbags which incorporate illuminated elements includes the following patents.

U.S. Patent Publication No. US 2005/0057923A1 by Catherine Kurcz, et al. for a Method and Apparatus to Illuminate the Interior of a Fashion Accessory, shows a handbag in which a pair of electroluminescent wires is coupled to a switch and to a power source. The switch is a magnetic reed switch which turns the electroluminescent wires on when the handbag is opened.

U.S. Patent Publication No. US 2005/0219839A1 to Juli R. Branson for a Lighted Purse shows a purse with a rechargeable battery and a solar call which are connected to an electroluminescent strip. A spring operated switch operates the electroluminescent strip when the purse is opened.

U.S. Patent Publication No. US 2005/0281019A1 by Steven N. Verona for a Receptacle Illuminating Device shows a light emitting membrane which has a backbone made of malleable wires which can be bent to conform to the interior shape of a handbag. A rocker switch, a battery and an inverter are mounted on the interior surface of the handbag. The rocker switch is used to turn the light emitting membrane on and off

U.S. Patent Publication No. US 2003/0090895A1 by Salvatore Guerrieri for a Portable Light Source and Retainer for Mounting, includes a battery powered LED, a microprocessor, a timer, and a switch and a magnetically actuable switch all of which are mounted in a ladies handbag or briefcase. When the handbag is opened, the magnetic switch closes a circuit and turns the LED on for a predetermined period of time. The manual switch can be used to turn the LED on or off at any time.

U.S. Pat. No. 2,877,439 to R. W. Avery for An Electrical Slide Fastener shows a slide fastener in which the elements of the slide fastener are made up of conducting and insulating interlocking elements which are physically spread over a large area. Electrical leads are provided which are attached to the interlocking contact element. The electrical leads form a closed circuit when the slide fastener is closed and an open circuit when the slide fastener is opened.

U.S. Pat. No. 6,801,140 B2 to Jani Mantyjarvi, et al. for A System and Method for Smart Clothing and Wearable Electronic Devices, shows a zipper having interlocking teeth with a two part conductive cable. Each of the two parts of the conducting cable is integral with one tooth of a pair of interlocking teeth. The two parts of the cable are brought into conducting position thereby completing the cable when the pair of interlocking teeth are interlocked.

U.S. Pat. No. 4,603,327 to O. P. Leonard, et al. for a Garment With Fastener Alarm, shows a zipper which includes a pair of electrical contacts in the zipper track for contact by the zipper head as the zipper head moves along the zipper track. The zipper head establishes continuity through the contacts as it moves past the contacts.

Despite the developments of the prior art, there remains a need for an effective illumination device for a handbag which combines an esthetically pleasing appearance with high reliability and low manufacturing cost.

### OBJECTS AND SUMMARY OF THE INVENTION

It is an object of the present invention to provide a handbag incorporating an electrical switch which provides a smooth and esthetically pleasing appearance.

Another object of the present invention is to provide a handbag incorporating an electrical switch which does not rely on the conductivity of interlocking elements to provide a switching action.

Another object of the present invention is to provide a handbag having a fastener incorporating an electrical switch which uses a reed switch.

Another object of the present invention is to provide a handbag having an electrical switch which incorporates an electrical timer.

Another object of the present invention is to provide a fastener incorporating an electrical switch which is adapted for use on handbags in combination with an electroluminescent panel.

Another object of the present invention is to provide a handbag incorporating an electrical switch in which the switch elements remain hidden from sight during normal operation.

Another object of the present invention is to provide a handbag having a fastener incorporating an electrical switch which does not rely on a contact type of switch.

Another object of the present invention is to provide a handbag having a fastener incorporating an electrical switch which does not rely on conductive wires connected to interlocking elements of the fastener.

Another object of the present invention is to provide a handbag incorporating a segmented illuminated panel which enables the side panels of the handbag to provide a degree of flexibility which results in convenient use.

Yet another object of the present invention is to provide a handbag having a fastener incorporating an electrical switch which comprises a small number of relatively simple components resulting in reliable long term operation and low cost manufacture.

Other objects and advantages of the present invention will be made clear hereinafter.

In accordance with the present invention, there is provided a handbag which includes a fastener incorporating an electrical switch which incorporates a zip type of fastener having a slide member and a plurality of interlocking teeth. The slide member may be selectively operated to cause the teeth to engage and interlock thus closing the fastener or to disengage thus opening the fastener. The lower portion of the slide member includes a magnet.

A reed switch is positioned at the fully open position of the zip fastener below the interlocking teeth. When the slide member approaches the reed switch, the magnet actuates the reed switch causing the reed switch to close. The reed switch is part of an electrical circuit which, in a preferred embodiment, includes a timer, an electroluminescent panel and a battery. The electroluminescent panel, the reed switch and the battery are mounted in the handbag in an unobtrusive manner which maintains the esthetic appearance of the handbag.

When the zip fastener is opened fully, the magnet causes the reed switch to close thereby completing the electrical circuit which causes the electroluminescent panel to illuminate the contents of the handbag for a predetermined time as controlled by the timer. When the zip fastener is pulled toward the closed position, the electroluminescent panel is turned off. The user sees the light turning off and is thus assured that the handbag is operating correctly.

### BRIEF DESCRIPTION OF THE DRAWINGS

Other important objects and advantages of the present invention will be apparent from the following detailed description of the invention taken in connection with the accompanying drawings in which:

FIG. 1 is a top plan view of a fastener incorporating an electrical switch according to the present invention;

FIG. 2 is a cross-sectional view taken along the line 2-2 of FIG. 1 showing the slide member;

FIG. 3 is a schematic drawing of the electrical circuit portion of the fastener of FIG. 1;

FIG. 4 is an overall perspective view of the fastener of FIG. 1 installed on a handbag and showing the electroluminescent panel portion of the handbag; and

FIG. 5 is a cross-sectional view of the handbag taken along the line 5-5 of FIG. 4;

FIG. 6 is an end view taken along the line 6-6 of FIG. 1;

FIG. 7 is an overall perspective view of the fastener of FIG. 1 installed on a handbag incorporating a segmented illuminated panel; and

FIG. 8 is a schematic cross-section view taken along the line 8-8 of FIG. 7

### DETAILED DESCRIPTION OF THE INVENTION

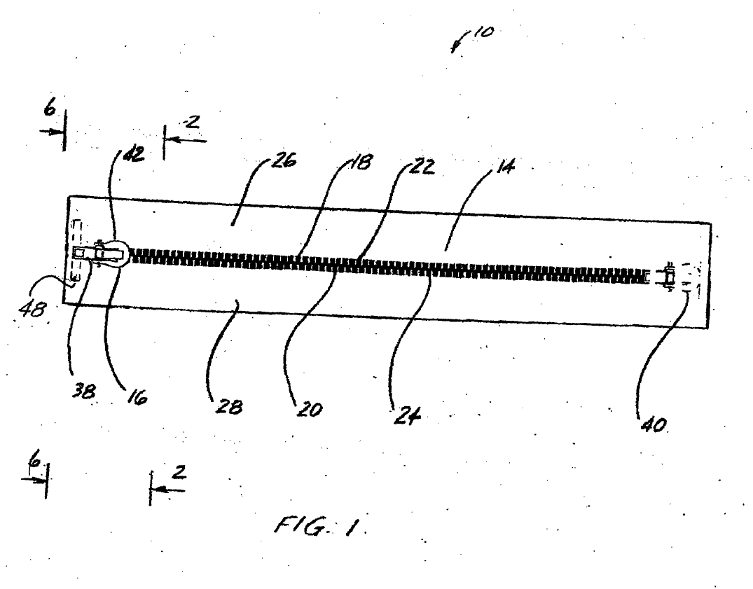

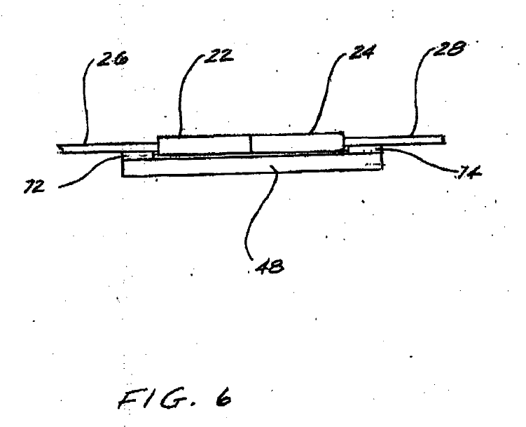

With reference to the drawings in which there is shown in FIGS. 1-6 a fastener incorporating an electrical switch 10 made according to the present invention and in which the fastener 10 is shown on a handbag 12.

FIG. 1 shows a top plan view of the fastener 10 according to the present invention which incorporates a zip type of fastener or closure 14. The zip fastener 14 has a slide member 16 and two rows 18, 20 of interlocking teeth which are identified typically by reference numerals 22, 24. The rows 18, 20 of interlocking teeth 22, 24 are mounted on adjacent flexible substrates 26, 28. The zip fastener 14 includes the slide member 16 which has upper and lower guide plates 32, 34 which are connected by a septum plate 36 and a pull tab 38 is mounted on plate 32. The details of construction of the interlocking teeth 22, 24 of the zip fastener 14 are conventional in nature and therefore need not be further described.

The zip fastener 14 may be operated in a conventional manner to move the slide member 16 from a closed position which is shown in broken lines 40 in FIG. 1 to an open position designated by reference numeral 42.

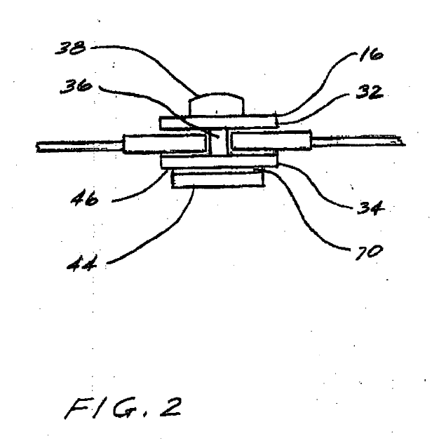

In accordance with the present invention, a permanent magnet 44 is mounted on the lower surface 46 of the lower guide plate 34 as is best shown in FIG. 2. The magnet 44 is connected to the lower surface 46 by an adhesive layer 70.

A reed switch 48 is mounted on the substrates 26, 28 adjacent to the open position 42 of the slide member 30. The reed switch 48 is mounted on the lower surfaces of the substrates 26, 28 by adhesive layers 72, 74 or by stitching so that neither the reed switch 48 nor the magnet 44 is visible to a user during normal operation of the zip fastener 14. The fastener 10 according to the present invention preserves the smooth esthetic appearance of a conventional zip fastener while providing the electrical switch function.

As a result of the location of the magnet 44 and the reed switch 48, both the magnet 44 and the reed switch 48 are hidden from view and are protected from accidental user contact and inadvertent damage.

It is clear that while a zip fastener 14 having interlocking teeth has been described above, the fastener according to the present invention may be incorporated in a slide fastener in which the interlocking teeth are replaced by interlocking elongated elements which are urged into a closed position by a slide member.

It is also clear that the fastener 10 of the present invention may find application in a broad range of devices which require a closure.

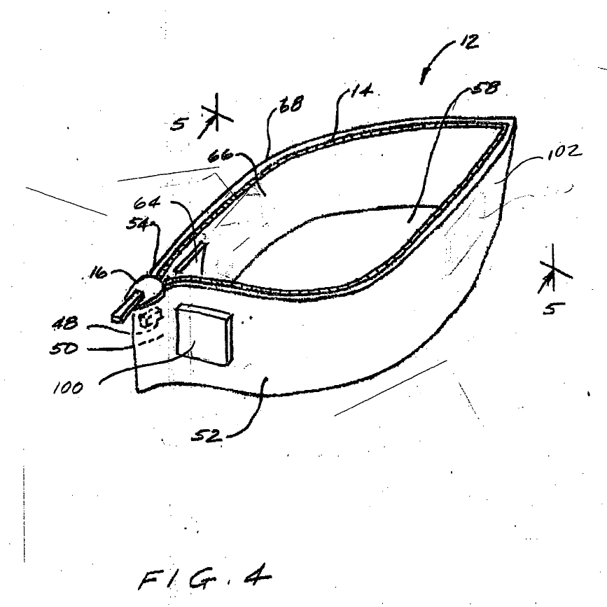

In a preferred construction, the reed switch 48 may be mounted on the inner surface 50 of a panel 52 of the handbag 12 near the fully open position 54 of the slide member 16 as is shown in FIG. 4.

When the slide member 30 approaches the reed switch 48, the magnet 44 actuates the reed switch 48 causing the reed switch 48 to close. The reed switch 48 is part of an electrical circuit 56 which includes an electroluminescent panel 58, a battery 60 and a timer 62.

When the fastener 10 is opened fully, the magnet 44 causes the reed switch 48 to close thereby completing an electrical circuit which causes the electroluminescent panel 58 to illuminate the contents of the handbag 12 for a predetermined time as controlled by the electrical circuit 56.

A preferred predetermined time period for the electroluminescent panel 58 to stay on is in the order of 15 seconds. If the slider 16 is moved to the closed position before predetermined period has elapsed, the light turns off. The light only comes on when the slider 16 is moved to the fully open position 54 and not when the handbag 12 has been partially opened.

When the fastener 10 is pulled toward the closed position, the electroluminescent panel 58 is turned off. The user sees the light turning off and is thus assured that the handbag 12 is operating correctly.

In FIG. 4, the components of the electrical circuit are shown disposed within an enclosure 64 which is mounted on the inner surface 66 of the panel 68 of the handbag 12.

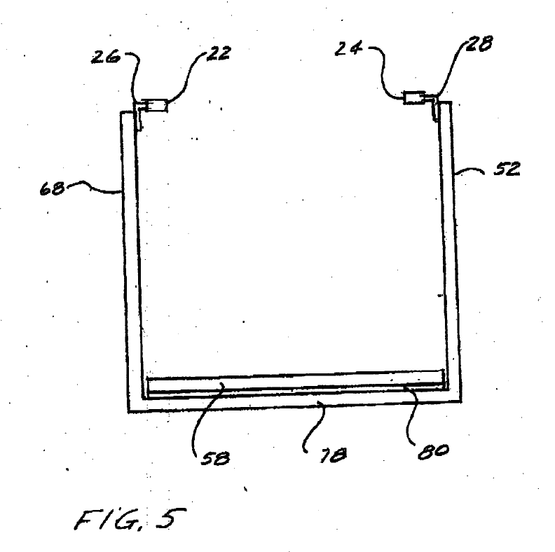

The handbag 12 as shown in FIG. 4 includes the panel 52, the panel 68 and the bottom panel 18. The panels 52, 68, 78 may be made of fabric, leather, plastic or any material which provides the requisite combination of properties of esthetic appeal with flexibility. The panels 52, 68, 78 may be fastened together to form the handbag by any one or combination of conventional fastening techniques including stitching and adhesive layers. The electroluminescent panel 58 is attached to the bottom panel 78 by an adhesive layer 80 as shown in FIG. 5 or alternatively, by conventional stitching.

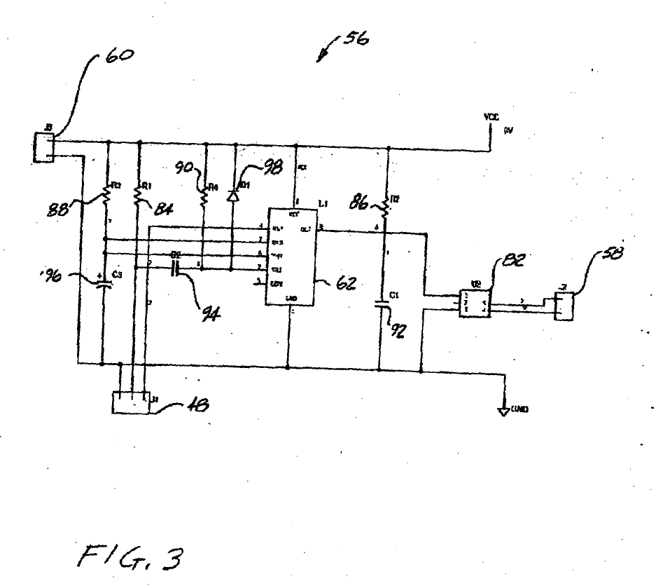

As is shown in FIG. 3 in the preferred construction, the electrical circuit 56 includes a solid state timer chip 62, a battery 60, a reed switch 48, an inverter 82, resistors 84, 86, 88, 90, capacitors 92, 94, 96, a diode 98, and the electroluminescent panel 58. The resistors 84, 86, 88, 90 are designated R1, R2, R3 and R4 respectively, and the capacitors 92, 94, 96 are designated C1, C2 and C3, respectively. Preferably the timer 62 is an LM555CM chip.

The functions of the various pins of the timer 62 are as follows. Pin I is ground, pin 2 is the trigger, pin 3 is the output, pin 4 is the reset, pin 5 is the control voltage and is not used, pin 6 is the threshold, pin 7 is the discharge, and pin 8 is positive Vcc.

Pin 1 of the timer 62 is connected to ground and pin 3, which is the output of the timer 62, is connected to the inverter 82 and the electroluminescent panel 58. Pin 2 which is the trigger of the timer 62, is connected to capacitor 62 and to the reed switch 48. Pins 6 and 7 are connected to resistor R3 and capacitor C4. Pin 2 is connected to capacitor C2 and to the moveable portion of the reed switch 48. Pin 2 is also connected to diode D1 and resistor R4. Resistor R2 and capacitor C1 are connected across pins 1 and 8.

The time period during which the electroluminescent panel 58 is on is determined by the values of resistor R3 and capacitor C3.

The inverter 82 converts the direct current provided by the battery 60 to alternating current for operation of the electroluminescent panel 58.

The electroluminescent panel 58 is flexible and provides an even illumination without creating heat or hot spots thus illuminating the contents of the handbag 12 in a convenient and effective manner.

FIG. 1 shows a solar panel 100 which may be mounted on the outside 104 of the handbag 12 to provide electrical power to charge the battery which may be a conventional rechargeable battery which includes a conventional battery charging circuit (not shown).

It should be understood that the reed switch and the permanent magnet described above may be replaced by a conventional microswitch (not illustrated) which has an actuating portion which is actuated by contact with the slide member when the slide member 16 reaches the open position.

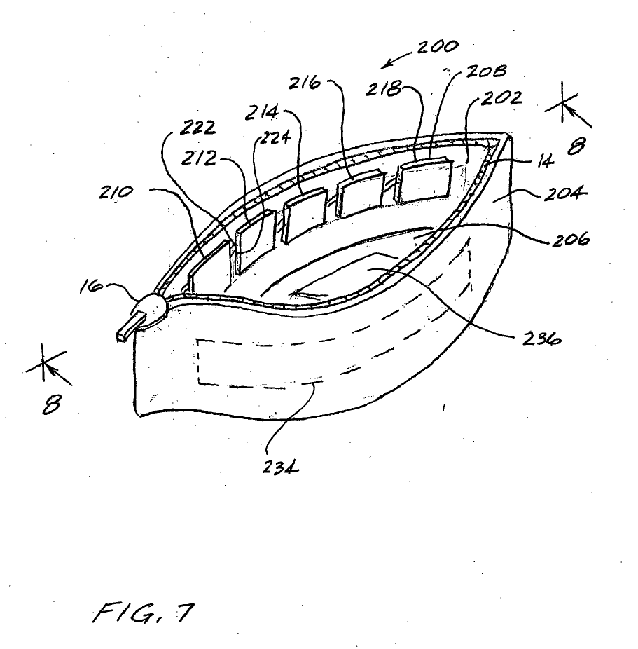

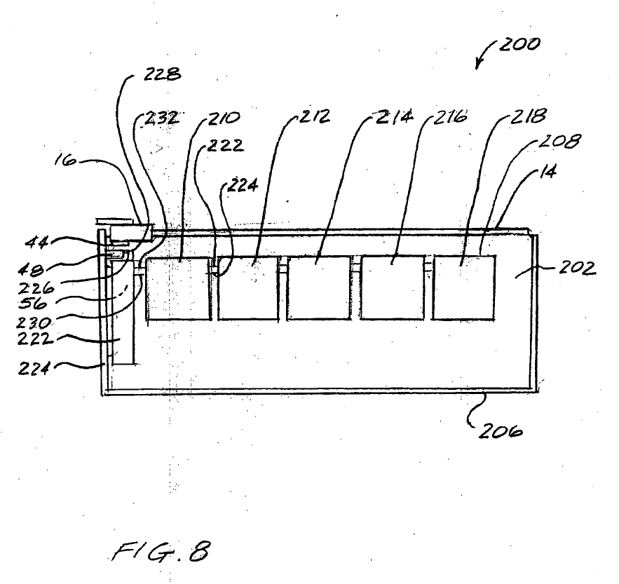

FIGS. 7 and 8 show an alternative embodiment 200 of the handbag 12 which was previously described in connection with FIG. 4. In FIG. 7, the handbag 200 includes the side panel 202, side panel 204 and the bottom panel 206. The panels 202, 204 and 206 may be made of any combination of fabric, leather, plastic or any material which provides the requisite properties of esthetic appeal and flexibility. As previously described, the panels 202, 204, 206 may be fastened together by any one or combination of conventional fastening techniques including stitching and adhesive layers.

As shown in FIGS. 7 and 8, the electroluminescent panel 208 is segmented and comprises a series of individual electroluminescent panels 210, 212, 214, 216, 218. The individual electroluminescent panels 210, 212, 214, 216, 218 are connected by wires typically indicated by wires 222, 224 shown in FIGS. 7 and 8. The individual electroluminescent panel 210 is connected to the electrical circuit 56 which is mounted in the enclosure 222 via wires 230, 232. The enclosure 222 is mounted on the side panel 202 by conventional attachment means. The enclosure 222 is mounted close to the end 224 of the side panel 202 thereby minimizing the length of the wires 226, 228 connecting the reed switch 48 and the electrical circuit 56 and also increasing the convenience for the user since the enclosure 222 is located in an area which does not interfere with the normal use of the handbag 200.

The segmented electroluminescent panel 208 has been illustrated as having five individual electroluminescent panels 210, 212, 214, 216, 218. The incorporation of individual electroluminescent panels 210, 212, 214, 216, 218 provides a high degree of flexibility which does not impair the normal flexibility of the side panel 202 and thereby facilitates the normal convenient use of the handbag 200.

The selection of the quantity of five individual electroluminescent panels 210, 212, 214, 216, 218 has been done as a matter of convenience and clarity of illustration. It is clear that a larger or smaller number of individual electroluminescent panels may be used depending on the overall size of the handbag and the degree of flexibility desired with a larger number of individual electroluminescent panels resulting in a more flexible construction for a given size of handbag.

The electroluminescent panel 208 has been illustrated as having mounted on the side panel 202. It is clear that a second electroluminescent panel similar to the electroluminescent panel 208 generally indicated by the broken lines 234 in FIG. 7 may be mounted on the side panel 204 and that a third electroluminescent panel generally indicated by the reference number 236 in FIG. 7 may be mounted on the bottom panel 206. The use of the second and third electroluminescent panels 234, 236 result in full illumination of the handbag 200.

The individual electroluminescent panels may be programmed by the electrical circuit 56 to light in a pre-selected sequence. The electroluminescent panel 208 is made of a flexible electroluminescent material which has properties similar to fabric. In an alternative construction (not illustrated), the electroluminescent panel may be used as the inner lining of the handbag thereby enabling the entire interior of the handbag to be illuminated. By way of example, tests conducted on the electroluminescent material of the electroluminescent panels have demonstrated the ability of the material to flex and bend in the order of 180 degrees around a radius which is in the order of 1 2mm.

One or more of the electroluminescent panels 208, 234, 236 may be printed with a variety of indicia including a company logo or a customized design. When the printed electroluminescent panels are illuminated, the indicia will become visible.

It should be understood that while the present invention has been described in connection with a handbag, this has been done by way of example and that the invention may be utilized with all manner of bags and compartments, including luggage, briefcases, garment bags, attache cases, jewelry boxes and glove boxes.

What is claimed is:

1. A handbag with an illuminated panel comprising:
handbag means having an aperture and an inner surface;
fastener means mounted on said handbag means and disposed adjacent to said aperture for reversibly closing said aperture, with said fastener means comprising;
a slide member;
a magnet mounted on said slide member;
a plurality of interlocking means operable by said slide member to open and close said fastener means;
electrical switch means mounted on said inner surface of said handbag means with said electrical switch means operable by said magnet;
electrical circuit means with said electrical circuit means disposed within said handbag means and with said electrical circuit means connected to said switch means;
illuminated panel means with said illuminated panel means disposed within said handbag means and with said illuminated panel connected to said electrical circuit means for illumination responsive to said magnet being moved proximate to said electrical switch means.

2. A handbag with an illuminated panel as claimed in claim 1 wherein said fastener means comprises a plurality of interlocking teeth.

3. A handbag with an illuminated panel as claimed in claim 1 wherein said slide member comprises an upper plate and a lower plate and wherein said permanent magnet means are mounted on said lower plate.

4. A handbag with an illuminated panel as claimed in claim 1 wherein said electrical switch means comprises a reed switch.

5. A handbag with an illuminated panel as claimed in claim 1 wherein said electrical circuit means comprises a timer.

6. A handbag with an illuminated panel as claimed in claim 1 wherein said electrical circuit means comprises an inverter.

7. A handbag with an illuminated panel as claimed in claim 1 wherein said illuminated panel comprises an electroluminescent panel.

8. A handbag with an illuminated panel as claimed in claim 1 wherein said slide member has an open position and a closed position and wherein said electrical switch means is disposed proximate to said open position.

9. A handbag with an illuminated panel as claimed in claim 5 wherein said timer comprises a solid state chip.

10. A fastener with a magnetic switch comprising:
a substrate;
a plurality of interlocking teeth mounted on said substrate;
slide means mounted on said interlocking teeth for opening and closing said interlocking teeth;
a magnet mounted on said slide means; and
electrical switch means operable by said magnet with said electrical switch means mounted on said substrate.

11. A fastener with a magnetic switch as claimed in claim 10 further comprising:
electrical circuit means having a timer with said electrical circuit means connected to said electrical switch means.

12. A fastener with a magnetic switch comprising:
a substrate;
at least one pair of interlocking members;
slide means mounted on said at least one pair of interlocking members for opening and closing said interlocking members;
a magnet mounted on said slide means; and
electrical switch means operable by said magnet with said electrical switch means mounted on said substrate.

13. A handbag with an illuminated panel as claimed in claim 1 further comprising:
a solar panel with said solar panel disposed on said handbag means and with said handbag means connected to said electrical circuit means.

14. A handbag with an illuminated panel as claimed in claim 1 wherein said magnet comprises a permanent magnet.

15. A handbag with an illuminated panel comprising:
handbag means having an aperture and an inner surface;
fastener means mounted on said handbag means and disposed adjacent to said aperture for reversibly closing said aperture, with said fastener means comprising;
a slide member having an open position and a closed position;
a plurality of interlocking means operable by said slide member to open and close said fastener means;
electrical switch means mounted on said inner surface of said handbag means with said electrical switch means operable by said slide member;
electrical circuit means with said electrical circuit means disposed within said handbag means and with said electrical circuit means connected to said switch means;
illuminated panel means with said illuminated panel means disposed within said handbag means and with said illuminated panel connected to said electrical circuit means for illumination responsive to said slide member being moved proximate to said open position.

16. A handbag with an illuminated panel as claimed in claim 15 wherein said illuminated panel means comprises segmented illuminated panel means.

17. A handbag with an illuminated panel as claimed in claim 15 wherein said illuminated panel comprises a lining of said handbag.

18. A handbag with an illuminated panel as claimed in claim 15 wherein said switch means comprises microswitch means.

19. A handbag with an illuminated panel as claimed in claim 15 wherein said illuminated panel means comprises illuminated panel means having indicia printed thereon.
